(19) United States
(12) Patent Application Publication
(10) Pub. No.: US 2004/0244708 A1
(43) Pub. Date: Dec. 9, 2004

(54) Disposable litter box

(76) Inventors: Gregg Neil, New Smyrna Beach, FL (US); Brad Richdale, Laguna Niguel, CA (US); Doug Gravink, Cimi Valley, CA (US); Gary Hewitt, Woodland Hills, CA (US)

Correspondence Address: RUSS, AUGUST & KABAT, Suite 1200, 12424 Wilshire Boulevard, Los Angeles, CA, 90025, US

(21) Appl. No.: 10/763,236

(22) Filed: Jan. 26, 2004

Related U.S. Application Data
(60) Provisional application No. 60/442,076, filed on Jan. 24, 2003.

(51) Int. Cl. A01K 29/00

(52) U.S. Cl. 119/168

(57) ABSTRACT

A tray contains a bag of litter and provides four sides to form a litter box. An enclosure folds into a flat configuration against the top of the tray. In use, the panels of the enclosure unfold and form an enclosure for the tray. Closure panels fold upwardly from the tray and interlock with the unfolded panels to add stability. The closure panels are provided with openings to allow the ingress and egress of cats. When desired, the panels can be folded back into the flat configuration and the entire unit disposed of.

This application claims benefit of Provisional Application 60/442,076 filed Jan. 24, 2003.

### FIELD OF THE INVENTION

The invention is directed to a disposable litter box made from multi-section panels open from a flat configuration to an assembled disposable box.

### BACKGROUND OF THE INVENTION

Cat owners need to provide a litter box for the cat. The litter needs to be changed on a regular basis and most cat owners do not enjoy this task. With the long standing domestication of cats, many types of litter boxes have been developed and used in the marketplace.

Litter boxes are often made of plastic and, to facilitate the cleaning of litter boxes, are used with liners to contain the cat litter. When the liner is removed, the litter is also removed. This procedure necessitates placing a liner in the litter box and filling the litter box with litter. Litter is dispensed and stored in large bags. This typical method is inconvenient and time consuming.

There is a need in the prior art for a single, self-contained unit supplying both the litter and the litter box. The self-contained unit must have the ability to be set up, used by the cat and easily disposed after use.

It is an object of the invention to provide a disposable litter box provided with litter.

It is another object of the invention to provide a litter box that is transported and sold in a flat configuration and converted into a setup, usable configuration.

It is another object of the invention to provide a disposable litter box made a biodegradable material.

These and other objects of the invention will become apparent to one of ordinary skill in the art after reading the disclosure of the invention.

### SUMMARY OF THE INVENTION

A tray contains a bag of litter and provides four sides to form a litter box. An enclosure folds into a flat configuration against the top of the tray. In use, the panels of the enclosure unfold and form an enclosure for the tray. Closure panels fold upwardly from the tray and interlock with the unfolded panels to add stability. The closure panels are provided with openings to allow the ingress and egress of cats. When desired, the panels can be folded back into the flat configuration and the entire unit disposed of.

### BRIEF DESCRIPTION OF THE DRAWINGS

FIG. 1 is a top view of the blank used to make the tray;

FIG. 2 is a top view of the blank used to make the enclosure;

FIGS. 3a-3f depict the transformation of the box from the flat to the assembled condition;

FIG. 4 is a top view of the second embodiment of the blank used to make the tray; and

FIG. 5 is a top view of the second embodiment of the blank used to make the closure.

### DETAILED DESCRIPTION OF THE INVENTION

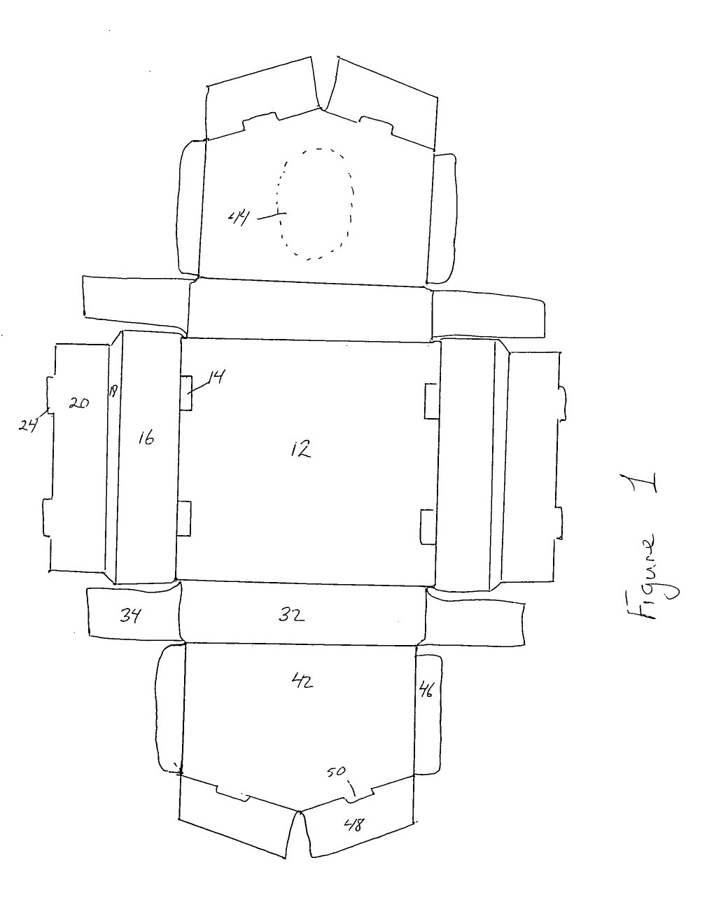

The tray forming part of the invention has a bottom wall 12 provided with a pair of slots 14 at each side, as seen in FIG. 1. An outer wall 16 is foldably connected to the bottom wall 12 at one end and to a bridge panel 18 at its opposite end. Attached to the bridge panel 18 is inner side wall 20 having a pair of tabs 24 at its free edge.

End walls 32 extend from the remaining two edges of the bottom wall 12. Each end wall 32 has a of corner flaps 34 extending from the side edges. Closure flaps 42 extend from each end wall 32 and have a pair of side flaps 46. The top of the closure flap is slightly peaked in the middle and a pair of top flaps 48 extend from the top edge. Formed in the top edge of the closure flap 42 is a pair of tabs 50.

To assemble the tray from the blank into the erected condition, end walls 32 are folded up with corner flaps folded perpendicular to the end walls and over the bottom wall 12. After outer side walls 16 are folded up, the inner side walls are folded downwardly until tabs 24 engage slots 14. When this is done, corner flaps 34 are captured between the inner and outer side wall. The two fold lines on either side of bridge panel 18 facilitate the folding of the inner side wall 180° from being coplanar with the outer side wall to the final orientation. Closure panels 42 are folded inwardly to form the top of the tray with side flaps 46 folded inwardly to align against inner side wall 20.

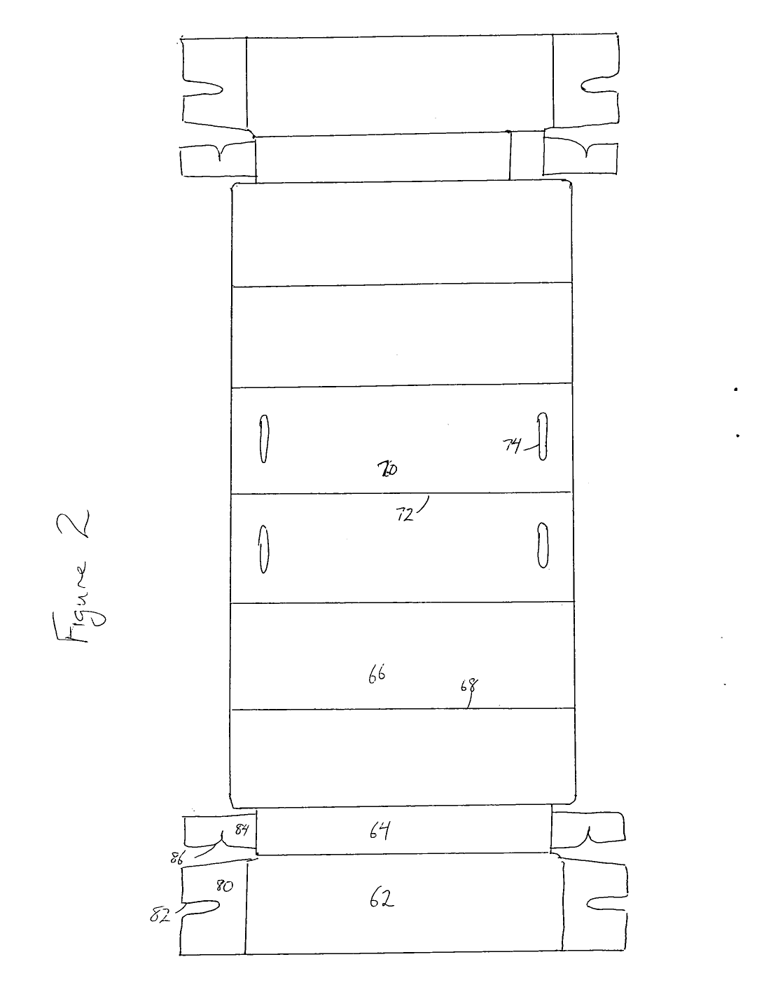

The blank for making the enclosure is seen in FIG. 2. The blank has a pair of bottom panels 62 each having a pair of bottom flaps 80 foldably extending from the side thereof. A base panel 64 with base flaps 84 extends from the side edge of each bottom panel. Foldably connected to the base panel 64 is side panel 66 bisected by fold line 68. Forming the middle of the blank is top panel 70 bisected by fold line 72 and provided with notches 74 for reasons that will be explained later.

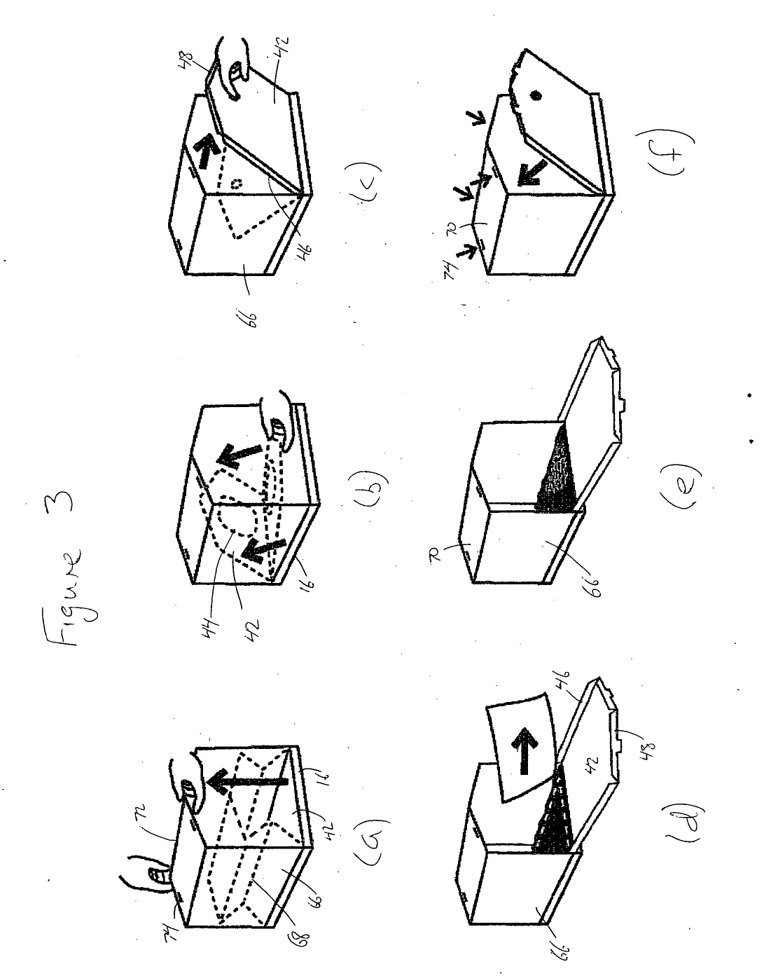

When the enclosure blank is formed together with the tray, the bottom panels 62 lie against bottom wall 12 with base panel 64 lying against inner side walls 20. With bottom panel 62 perpendicular to base panel 64, slot 86 in base flap 84 engages notch 82 in bottom flap 80 to lock two flaps together. Side panel 66 extends between the inner side wall 20 and side flaps 46. Fold lines 68 allows the sidewalls to fold in an accordion-like manner and lie against the closure flaps 42. When folded, the upper section of side panel rests upon the lower section. Extending across the folded side panels 66 and across the top of the tray is the top panel 70. This folded, compact configuration is seen in FIG. 3.

Transformation of the device from the flat configuration to the useable configuration is clearly shown in FIG. 3. FIG. 3A shows the enclosure transformed from the flat configuration to the fully formed configuration with the intermediate state shown in phantom. As can be seen, the side panel 66, originally lying against the top 42 of the tray is unfolded until the two sections of the side panel 66 formed by the bisecting fold lines 68 are coplanar. The fold line 72 in the top 70 allows the formation of a peaked top.

Once the enclosure is fully formed, the two closure flaps of the tray can be raised. The first closure panel 42 is raised until tabs 50 engage the notches 42, as seen in FIG. 3b. The second closure flap 42 is pulled all the way through the enclosure in order to access the cat litter stored within the tray, depicted in FIG. 3c-3e. The cat litter, usually packaged in a bag, is emptied into the tray. Thereafter, the closure flap is pushed upwardly until the tabs 50 engage notches 74, as seen in FIG. 3f. After use, the closure flaps 42 can be pushed inwardly until they again rest on top of the tray and the enclosure can be collapsed back into the flat configuration for disposal.

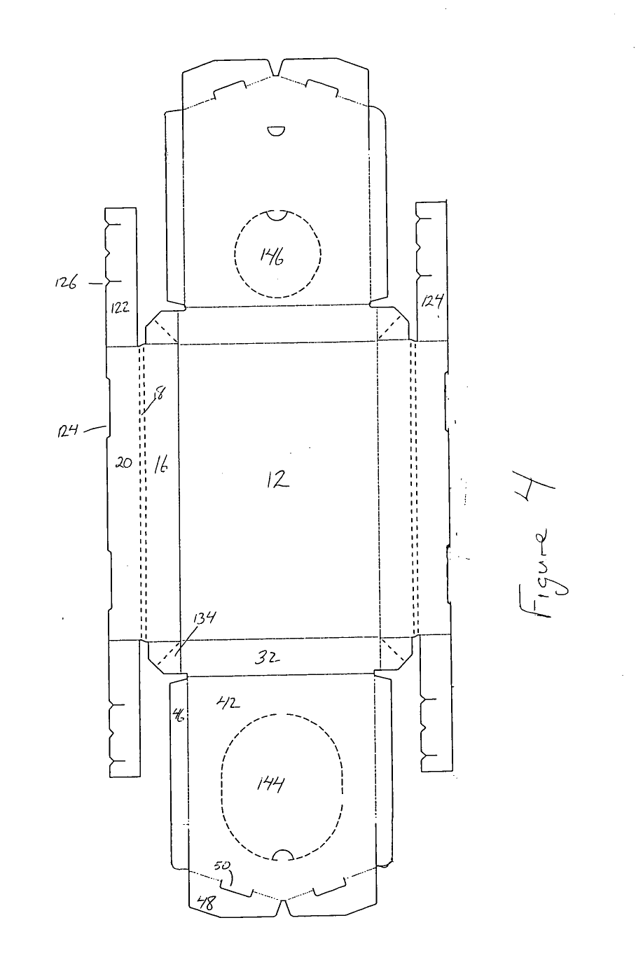

FIG. 4 shows an alternative embodiment of the blank for making the tray. All similar parts have been identified with the same reference numerals and only that structure which differs from the first embodiment will be described. In this embodiment, corner flaps 34 have been replaced with a corner fold 134 formed by two panels connected to one another and between the side and end walls. The free edge of the inner side wall 20 is provided with notches 124 as will be described hereinafter. Extending from the side edges of inner side wall 20 are wall flaps 122, 124. Each of these is provided with slots 126. The two wall flaps 122, 124 differ in their orientation of the slots 126 as, when assembled, slots 126 of the flap 122 face downwardly with slots 126 of flap 124 extending upwardly. The slots align with one another and allow the two flaps to interlock. Also differing from the first embodiment, one closure flap 42 is provided with a large opening 144 for cats with the second closure flap 142 provided with a smaller opening 146 for kittens.

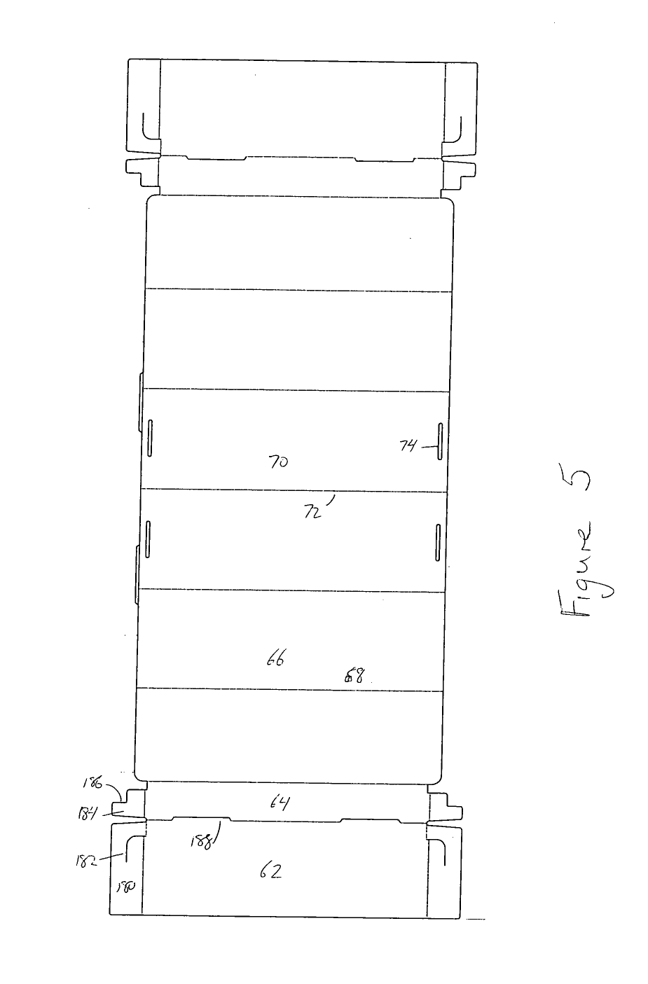

FIG. 5 shows the second embodiment of the blank for making the enclosure. In this embodiment, bottom panel 62 is provided with bottom flaps 180 having L-shaped cut 182. Base panel 64 is provided with base flaps 184 with an L-shaped free edge 186. When the enclosure is folded, bottom flap 80 is perpendicular to base flap 84 and the L-shaped free edge engages L-shaped notch 182 to interlock the two flaps. Between bottom panel 62 and base panel 64 are notches 188 which complement notches 124 to provide some degree of interlocking between the tray and enclosure blanks when folded.

The tray and enclosure are preferably made of degradable material such as cardboard. The blanks are provided with a coating, such as plastic or paraffin, to render the material waterproof.

While the invention has been described with reference to a preferred embodiment, variations and modifications would be apparent to one of ordinary skill in the art. The invention encompasses such variations and modifications.

I claim:

1. A litter box, comprising:
a tray having a bottom, a pair of side wall and a pair of end walls,
an enclosure comprising:
a pair of side panels extending above said tray end walls, and
a top panel extending between said enclosure side walls.

2. The litter box of claim 1, wherein said tray further comprises a pair of closure flaps foldably connected to said pair of end walls.

3. The litter box of claim 2, further comprising side flaps attached to the sides of said closure flaps and top flaps attached to top edges of said closure flaps.

4. The litter box of claim 2, further comprising:
tabs extending from the top edge of said closure flaps,
apertures in said enclosure top panel, and
said tabs engaging said aperture to retain said closure flaps in an upright position.

5. The litter box of claim 2, further comprising a removable panel in at least one closure flap.

6. The litter box of claim 1, wherein said enclosure further comprises a pair of bottom panels extending along said tray bottom, and a pair of base panels extending along tray side walls, said base panels foldably connected to said pair of bottom panels and said pair of enclosure side walls.

7. The litter box of claim 6, further comprising a pair of bottom flaps connected to each bottom panel, a pair of base flaps connected to each base panel, said base flaps interlocking with said bottom flaps.

8. The litter box of claim 7, further comprising an L-shaped cut in said bottom flaps, an L-shaped free edge in said base flaps, said L-shaped free edge engaging said L-shaped cut.

9. The litter box of claim 1, wherein said tray side walls comprise an inner side wall and an outer side wall, wall flaps attached to said inner side wall and extending along said tray end walls, and wall flaps from opposing side walls interlocking with each other.
